(19) United States
(12) Patent Application Publication
(10) Pub. No.: US 2013/0318576 A1
(43) Pub. Date: Nov. 28, 2013

(54) METHOD, DEVICE, AND SYSTEM FOR MANAGING USER AUTHENTICATION

(71) Applicants: Gyan Prakash, Beaverton, OR (US); Selim Aissi, Menlo Park, CA (US); Rajesh Poornachandran, Portland, OR (US)

(72) Inventors: Gyan Prakash, Beaverton, OR (US); Selim Aissi, Menlo Park, CA (US); Rajesh Poornachandran, Portland, OR (US)

(21) Appl. No.: 13/997,746

(22) PCT Filed: Dec. 31, 2011
(86) PCT No.: PCT/US11/68280

§ 371 Date: Jun. 25, 2013

(51) Int. Cl. H04L 29/06

(52) U.S. Cl. CPC H04L 63/083
USPC 726/4

(57) ABSTRACT

A method, device, and system for managing user authentication includes receiving authentication constraints of authentication data used to authenticate a user of a first computing device, such as a mobile computing device, to a second computing device, such as a financial data, e-commerce server or cloud-based service server. The first computing device automatically generates authentication data as a function of the authentication constraints. The authentication data may be embodied as a strong password and username. The authentication data may be updated or regenerated periodically or responsively to further increase the security of the authentication data. The user authentication data, authentication constraints, and history of transactions may be performed in a secure execution environment to further increase the security of the method, device and system.

### BACKGROUND

Computer systems and other electronic devices utilize user authentication mechanisms to verify the identity of users and control access to important or sensitive data and functionality. There are many different types of user authentication mechanisms that are used for such purposes including, for example, user password mechanisms, certificate-based authentication mechanisms, challenge-response mechanisms, security tokens, biometrics, face and voice recognition, and the like.

Systems relying on user password mechanisms are increasingly requiring strong passwords that may require passwords of many characters (e.g., twenty characters or longer), passwords of using special characters, and/or nonsensical structure. However strong passwords are difficult for users to remember and recall when needed without the use of a physical backup copy of the strong password, which reduces the security effectiveness of the password itself. Additionally, many computer systems, such as financial systems, require users to periodically update or change their passwords. Such updating requirements further increase the difficulty for users to maintain strong passwords. This is especially true in those circumstances in which the user is interfacing with multiple computer systems and electronic devices, each of which may require strong, frequently-changed passwords.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for managing user authentication to multiple vendor servers or systems;

FIG. 2 is a simplified block diagram of at least one embodiment of a software environment of a computing device of FIG. 1;

FIG. 3 is a simplified flow diagram of at least one embodiment of a method for establishing local user authentication data, which may be executed by the computing device of FIG. 1;

FIG. 4 is a simplified flow diagram of at least one embodiment of a method for authenticating a user with a vendor server; and

FIG. 5 is a simplified flow diagram of at least one embodiment of a method for authenticating a user to the computing device of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings or schematic elements, such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, module routines, processes, procedure plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

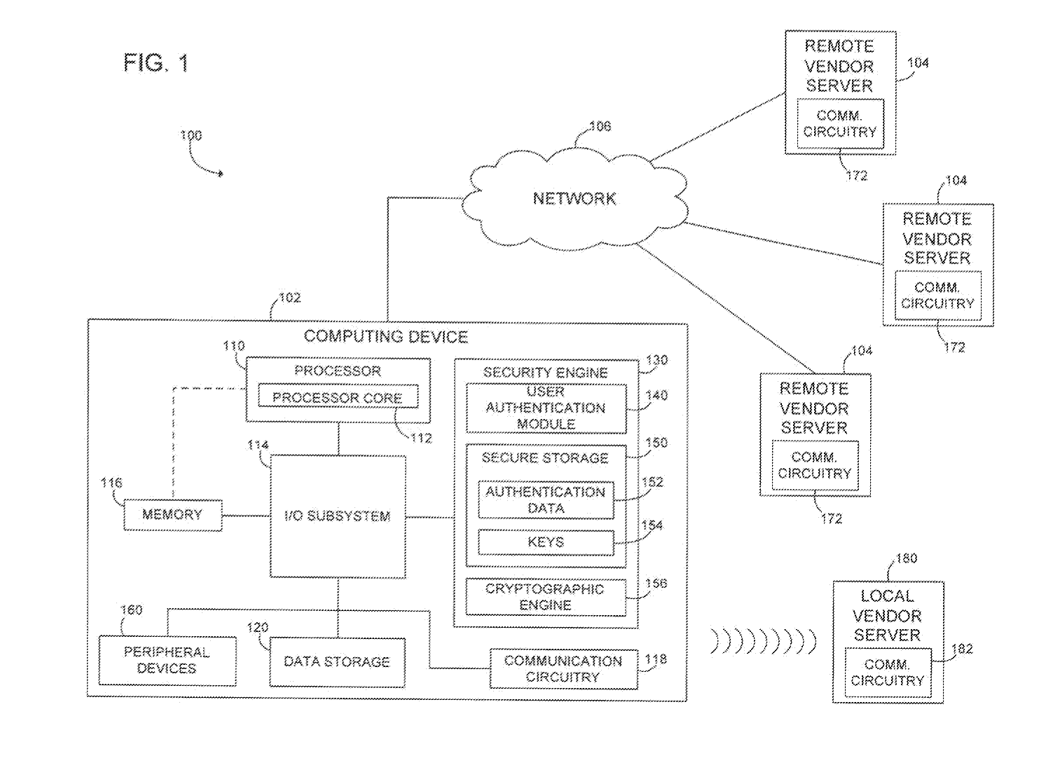

Referring now to FIG. 1, a system 100 for managing user authentication includes a computing device 102 and a plurality of remote vendor servers 104. The computing device 102 may optionally communicate with each of the vendor servers 104 over a network 106. In use, the computing device 102 is configured to generate and maintain authentication data to authenticate a user of the computing device 102 to each of the remote vendor servers 104. The authentication data may include any type of data required by the respective remote vendor server 104 to authenticate the user thereto. In one embodiment, for example, the authentication data is embodied as a username and password. However, because the computing device 102 generates and maintains the authentication data, rather than the user of the computing device 102, the username and password for each remote vendor server 104 may be selected to be exceptionally strong and unique across the remote vendor servers 104. Alternatively, in other embodiments, the authentication data may be embodied as digital identity data, such as a hash of a hardware identification number or the like.

As discussed in more detail below, the computing device 102 generates the authentication data by receiving or inferring authentication constraints from the vendor servers 104. The authentication constraints may be embodied as any type of data that defines or limits any quality of the authentication data such as the format, size, subject matter, permutation order, available characters, font, uniqueness, or other quality of the authentication data. For example, in some embodiments, the authentication constraints may define a minimum password length and a requirement that one or more special characters (e.g., the ampersand character) be included in the password. The computing device 102 generates the authentication data so as to satisfy the authentication constraints received from each of the remote vendor server 104. In some embodiments, the computing device 102 generates and manages the authentication data with little or no input from the user (e.g., the user may have no knowledge of the generated username and password). Additionally, to further increase the security of the authentication data or response to a requirement of a vendor server 104, the computing device 102 may periodically or responsively update or change the authentication data.

Once generated, the computing device 102 may automate the authentication process (e.g., the login process) of the user to the remote vendor server 104 using the generated authentication data. To do so, the computing device 102 may, in some embodiments, first authenticate the user to the computing device 102 itself. The computing device 102 may use any suitable methodology to authenticate the user including a password mechanism, biometric data, face/voice recognition, key token, and/or the like. In some embodiments, the user need only authenticate to the computing device 102 once. However, in, other embodiments, the computing device 102 may require the user to authenticate to the computing device 102 periodically or in response to a request to communicate with one of the remote vendor servers 104. Regardless, because the user need only authenticate to the computing device 102, rather than to each vendor server 128, the user may select a single, strong password or other security measure, which may be easier to remember and/or manage relative to multiple strong password or devices.

If the user is successfully authenticated to the computing device 102, the user may operate the computing device 102 to access any of the remote vendor servers 104. In so doing, the computing device 102 is configured to automate the authentication of the user by retrieving the generated authentication data for the corresponding vendor server 104 and transmitting, or otherwise, providing the authentication data to the respective vendor server 104 to thereby authenticate the user to the vendor server 104. In this way, the computing device 102 generates and maintains strong, unique authentication data for each of the vendor servers 104, which increases the user's overall security.

The computing device 102 may be embodied as any type of computing device capable of performing the functions described herein. In one particular embodiment, the computing device 102 is embodied as a mobile computing device such as a smart phone, a tablet computer, a laptop computer, a mobile internet device (MID), a personal digital assistant, or other mobile computing or electronic device. In other embodiments, the computing device 102 may be embodied as a substantially stationary computing or electronic device such as a desktop computer, smart appliance, and/or the like.

In the illustrative embodiment of FIG. 1, the computing device 102 includes processor 110, an I/O subsystem 114, a memory 116, communication circuitry 118, data storage 120, a security engine 130, and one or more peripheral devices 160. In some embodiments, several of the foregoing components may be incorporated on a motherboard of the computing device 102, while other components may be communicatively coupled to the motherboard via, for example, a peripheral port. Furthermore, it should be appreciated that the computing device 102 may include other components, sub-components, and devices commonly found in a mobile computing device, which are not illustrated in FIG. 1 for clarity of the description.

The processor 110 of the computing device 102 may be embodied as any type of processor capable of executing software/firmware, such as a microprocessor, digital signal processor, microcontroller, or the like. The processor 110 is illustratively embodied as a single core processor having a processor core 112. However, in other embodiments, the processor 110 may be embodied as a multi-core processor having multiple processor cores 112. Additionally, the computing device 102 may include additional processors 110 having one or more processor cores 112.

The I/O subsystem 114 of the computing device 102 may be embodied as circuitry and/or components to facilitate input/output operations with the processor 110 and/or other components of the computing device 102. In some embodiments, the I/O subsystem 114 may be embodied as a memory controller hub (MCH or “northbridge”), an input/output controller hub (ICH or “southbridge”), and a firmware device. In such embodiments, the firmware device of the I/O subsystem 114 may be embodied as a memory device for storing Basic Input/Output System (BIOS) data and/or instructions and/or other information (e.g., a BIOS driver used during booting of the computing device 102). However, in other embodiments, I/O subsystems having other configurations may be used. For example, in some embodiments, the I/O subsystem 114 may be embodied as a platform controller hub (PCH). In such embodiments, the memory controller hub (MCH) may be incorporated in or otherwise associated with the processor 110, and the processor 110 may communicate directly with the memory 116 (as shown by the hashed line in FIG. 1). Additionally, in other embodiments, the I/O subsystem 114 may form a portion of a system-on-a-chip (SoC) and be incorporated, along with the processor 110 and other components of the computing device 102, on a single integrated circuit chip.

The processor 110 is communicatively coupled to the I/O subsystem 114 via a number of signal paths. These signal paths (and other signal paths illustrated in FIG. 1) may be embodied as any type of signal paths capable of facilitating communication between the components of the computing device 102. For example, the signal paths may be embodied as any number of point-to-point links, wires, cables, light guides, printed circuitboard traces, via, bus, intervening device and/or the like.

The memory 116 of the computing device 102 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 116 is communicatively coupled to the I/O subsystem 114 via a number of signal paths. Although only a single memory device 116 is illustrated in FIG. 1, the computing device 102 may include additional memory devices in other embodiments. Various data and software may be stored in the memory 116. For example, one or more operating systems, applications, programs, libraries, and drivers that make up the software stack executed by the processor 110 may reside in memory 116 during execution.

The communication circuitry 118 of the computing device 102 may include any number of devices and circuitry for enabling communications between the computing device 102 and the remote vendor servers 104 over the network 106. The computing device 102 may use any suitable communication protocol to communicate with the vendor servers 104 over the network 106 depending on, for example, the particular type of network(s) 106. The network 106 may be embodied as any number of various wired and/or wireless communication networks. For example, the network 106 may be embodied as or otherwise include a local area network (LAN), a wide area network (WAN), or a publicly-accessible, global network such as the Internet. Additionally, the network 106 may include any number of additional devices to facilitate communication between the computing device 102 and the remote vendor server(s) 104.

In some embodiments, the communication circuitry 118 may also include a contactless communication mechanism, such as near-field communication (NFC) circuitry or Bluetooth® communication circuitry. In such embodiments, the computing device 102 may use the contactless communication mechanism to communicate with one or more local vendor servers 180 to authenticate the user of the computing device 102 in a manner similar to that used for authenticating the user to the remote vendor servers 104.

The data storage 120 may be embodied as any type of device or devices configured for the short-term or long-term storage of data such as, for example, memory devices and circuits, memory cards, hard disk drives, solid-state drives, or other data storage devices. Various software programs, such as an operating system and associated software applications, may be stored in the data storage 120 and loaded from the data storage 120 during operation of the computing device 102.

The security engine 130 may be embodied as any type of hardware and associated firmware configured to perform security, encryption, and/or authentication functions as described in more detail below. For example, the security engine 130 may be embodied as or otherwise include, a security co-processor, an out-of-band processor, a trusted platform module (TPM), and/or other security-enhancing hardware and/or associated software modules usable to establish a secure environment on the computing device 102. In the illustrative embodiment, the security engine 130 includes a user authentication module 140, a secure storage 150, and a cryptographic engine 156. It should be appreciated, however, that the security engine 130 may include additional modules and/or devices in other embodiments.

The user authentication module 140 may be embodied as various software, firmware, and/or associated hardware (e.g., logic units) configured to authenticate the user of the computing device 102 to the vendor servers 104, 180. To do so, as discussed in more detail below, the user authentication module 140 receives or infers authentication constraints from the vendor servers 104, 180 and generates authentication data 152 as a function of such authentication constraints. Additionally, the user authentication module 140 controls and manages the authentication of the user to the computing device 102 itself. As discussed above, the authentication data may be embodied as any type of data required by the vendor servers 104, 180 to authenticate (e.g., login) the user to the respective vendor server 104, 180 such as, for example, a username and associated password. The user authentication module 140 may store the authentication data in the secure storage 150, which may be embodied as secure memory local to the security engine 130 or as a secured partition of the memory 116. In some embodiments, the security engine 130 may also include a cryptographic engine 156 to perform various cryptographic functions using corresponding cryptographic keys 154. For example, in some embodiments, the communications between the computing device 102 and the vendor servers 104, 180 may be encrypted using the cryptographic engine 156.

In some embodiments, the computing device 102 may also include one or more peripheral devices 160. Such peripheral devices may include any number of additional input/output devices, interface devices, and/or other peripheral devices. For example, in some embodiments, the peripheral devices 160 may include a display for displaying information to the, user of the computing device 102 and a keyboard or other input device for receiving input from the user.

The vendor servers 104, 180 may be embodied as any type of data server, computing device, or other electronic device requiring authentication of the user of the computing device 102. For example, in some embodiments, one or more of the remote vendor servers 104 may be embodied as a financial data server, such as a bank server, an e-commerce server configured to facilitate online transactions, or a cloud-based service server configured to provide a cloud-based service to the computing device 102. Additionally, in some embodiments, the local vendor server 180 may be embodied as a financial computing device, such as an Automated Teller Machine (ATM) or other financial computing device requiring authentication of the user of the computing device 102. It should be appreciated that although the vendor servers 104, 180 are referred to herein as “vendor servers,” the servers 104, 180 may he embodied as any type electronic device requiring authentication of the user of the computing device 102. That is, in some embodiments, the vendor servers 104, 180 may not be embodied as standard data servers nor provide a particular product or service to the user. For example, in some embodiments, the vendor servers 104, 180 may be embodied as an electronic device requiring authentication of the user, such as a smart appliance, home computer, or the like.

The vendor servers, 104, 180 may include devices and structures commonly found in servers, computing devices, and other electronic devices, such as one or more processors, memory devices, I/O subsystems, data storage devices, and various peripheral devices, which are not illustrated in FIG. 1 for clarity of the description. For example, each of the remote vendor servers 104 may include communication circuitry 172 to facilitate communications with the computing device 102 over the network 106. Similarly, the vendor server 180 may include communication circuitry 182, such as contactless communication circuitry, to facilitate contactless communications with the computing device 102 as discussed above.

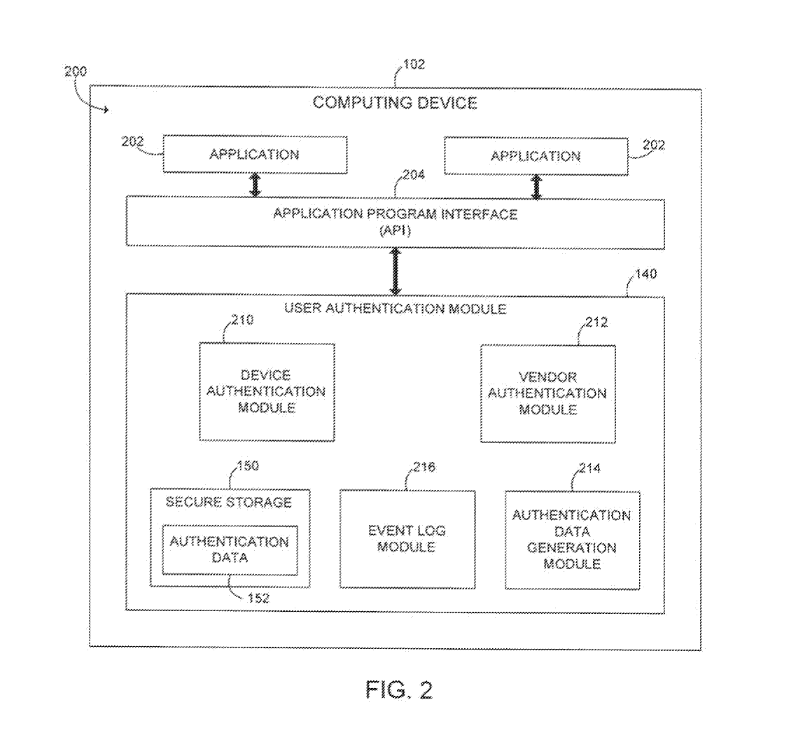

Referring now to FIG. 2, in use, the computing device 102 may establish an operating environment 200. The environment 200 illustratively includes one or more software applications 202, which may be configured to communicate, or otherwise interact, with the user authentication module 140 of the security engine 130 via one or more application program interfaces 204 (APIs). The software applications 202 may be embodied as any type of software applications executable on the computing device 102 (e.g., executable on an operating system of the computing device 102) and requiring use of the authentication functionality of the user authentication module 140 as discussed below. For example, the software applications 202 may include one or more web browsers, financial management applications, e-commence applications, or other software applications requiring or facilitating the authentication of the user of the computing device 102 to one or more vendor servers 104, 180.

As discussed above, the user authentication module 140 controls and manages the authentication of the user of the computing device 102 to the vendor servers 104, 180 and to the computing device 102 itself. To facilitate such functionality, in the illustrative embodiment of FIG. 2, the user authentication module includes a device authentication module 210, a vendor authentication module 212, an authentication data generation module 214, an event to module 216, and the secure storage 150. The device authentication module 210 facilitates and manages the user's authentication to the computing device 102 itself. For example, as discussed in more detail below, the device authentication module 210 may request authentication data, such as a password, biometric data, voice or face recognition, security token, or other authentication data, from the user and store such user authentication data in the secure storage 150. The device authentication module 210 may periodically or responsively request authentication of the user to the computing device 102 and verify the user's identity based on the user authentication data stored in the secure storage 150. In this way, the user of the computing device 102 is required to authenticate to the computing device 102 using a single instance of authentication data (e.g., a single password), which may allow the user authentication data to be stronger. For example, the user may utilize a stronger password for authenticating to the computing device 102 because the user need only remember a single password to authenticate himself/herself to multiple vendor servers 104, 180 as discussed below.

The vendor authentication module 212 manages and controls the authentication of the user of the computing device 102 to the vendor servers 104, 180. To do so, the vendor authentication module 212 initially obtains (e.g., receives, retrieves, or infers) authentication constraints from the vendor servers 104, 180, which define various aspects or qualities of the authentication data (e.g., password length, format, etc.). The vendor authentication module 212 passes such authentication constraints to the authentication data generation module 214, which generates authentication data as a function of the authentication constraints. That is, the authentication data generation module 214 generates authentication data (e.g., username and password) that may be used to authenticate the user of the computing device 102 to the respective vendor server 104, 180 and stores the generated authentication data in the secure storage 150. To do so, the authentication data generation module 214 may use any suitable methodology or algorithm to generate the authentication data. For example, in one embodiment, the authentication data generation module 214 may randomly generate the authentication data such that the randomized authentication data satisfies the authentication constraints. In such embodiments, the authentication data generation module 214 may randomize any aspect or quality of the authentication data. For example, in embodiments wherein the authentication data is a username and/or password, the authentication data generation module 214 may generate a username and/or password having a random length of randomized characters and/or randomized capitalization that, when generated, still satisfies the authentication constraints of the vendor server 104, 180. Additionally, in some embodiments, the authentication data generation module 214 may record a history of generated authentication data to ensure that each generated authentication data is unique with respect to previously generated authentication data such that no authentication data is repeated.

Once the authentication data generation module 214 has generated authentication data for a particular vendor server 104, 180, the vendor authentication module 212 may retrieve the authentication data from the secure storage 150 and use the authentication data to authenticate (e.g., login) the user to the respective vendor server 104, 180. For example, the vendor authentication module 212 may provide the authentication data to a remote vendor server 104 by transmitting the authentication data over the network 106.

In some embodiments, the user authentication module 140 may also include an event log module 216. The event log module 216 monitors the operation of the user authentication module 140 and logs various events for later analysis. For example, should some security event occur (e.g., the user is unable to authenticate himself/herself to the computing device 102), the event log module 216 may record such security event. Additionally, in some embodiments, if the occurrence of security events reaches a reference threshold, the event log module 216, or other security module of the security engine 130, may be configured to perform one or more security functions such as a locking the computing device 102, shutting down the communication circuitry 118, and/or the like.

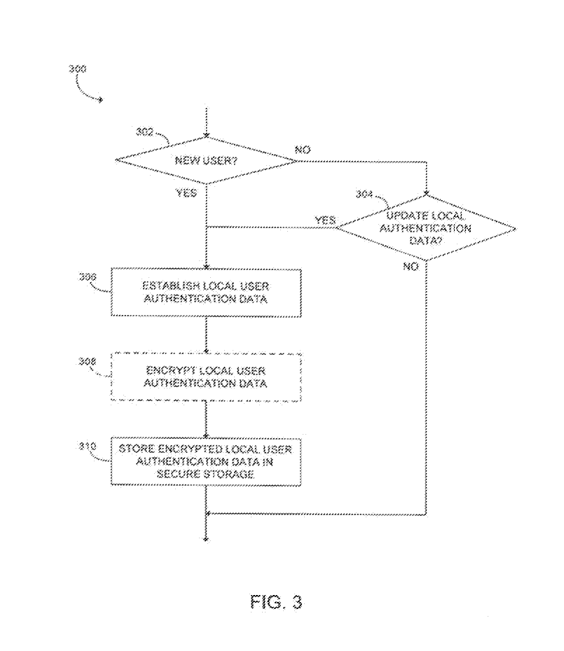

Referring now to FIG. 3, as discussed above, the computing device 102 may execute a method 300 for establishing local user authentication data to authenticate the user to the computing device 102 itself. The method 300 may be executed by, for example, the device authentication module 210 of the user authentication module 140. The method 300 begins with block 302 in which the device authentication module 210 determines whether the user is a new user to the computing device 102. In some embodiments, the computing device 102 may support multiple users, each of whom may be authenticated to the same or different vendor servers 104, 180 using different authentication data. The device authentication module 210 may determine whether the user is a new user by promoting the user for such information, based on entry of pre-established user authentication data, and/or other suitable methodology. If the user is not a new user, the method 300 advances to block 304 in which the device authentication module 210 determines whether the existing user would like to update or change his/her existing authentication data. In some embodiments, the user may initiate the updating or changing of the authentication data. Alternatively, the device authentication module 210 may require periodic updates/changes to the user authentication data used to authenticate the user to the computing device 102. If no update/changes to the user authentication data are required, the method 300 exits.

However, if the user is a new user (block 302) or it an existing user desires or is prompted to update/change existing authentication data (block 304), the method 300 advances to block 306 in which the device authentication module 210 establishes the local user authentication data. As discussed above, the user and/or device authentication module 210 may use any type of authentication data to authenticate the user to the computing device 102 depending on, for example, the type of computing device 102 and/or its intended function. For example, as discussed above, the user authentication data may be embodied as password data, biometric data, face/voice recognition data, key token data, and/or the like. The user may enter, or otherwise, supply the authentication data to the device authentication module 210 using the computing device 102 itself.

In block 308, the device authentication module 210 may encrypt the user authentication data in some embodiments. To do so, the device authentication module 210 may utilize the cryptographic engine 156 to encrypt the user authentication data. Regardless, in block 310, the device authentication module 210 stores the user authentication data in the secure storage 150 of the security engine 130. In embodiments wherein the computing device 102 has multiple users, the device authentication module 210 may store the user authentication data in the secure storage 150 in association with identification data of the respective user and/or in association with the generated authentication data for authenticating the user to the vendor servers 104, 180 as discussed below.

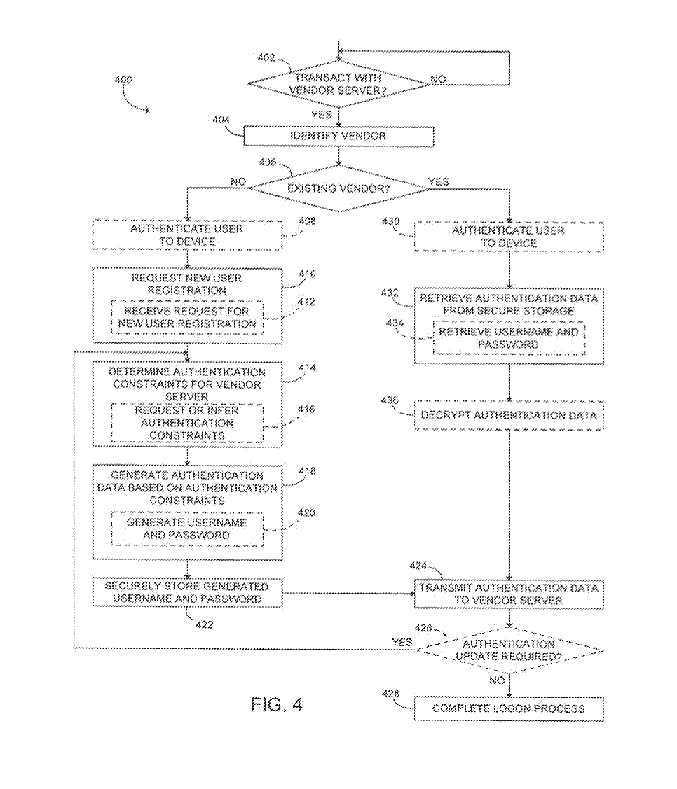

Referring now to FIG. 4, in use, the computing device 102 may execute a method 400 for authenticating a user of the computing device 102 to one or more vendor servers 104, 180. The method 400 begins with block 402 in which the vendor authentication module 212 of the user authentication module 140 determines whether a transaction with a vendor server 104, 180 is desired by the user. The vendor authentication module 212 may make such a determination based on, for example, communication traffic between the computing device 102 and the corresponding vendor server 104, 180, a request, received from the user or an application, and/or the like. If a transaction with a vendor server 104, 180 is desired, the method 400 advances to block 404 in which the vendor authentication module 212 identifies the vendor. To do so, the vendor authentication module 212 may again monitor the communication traffic between the computing device 102 and the vendor server 1.04, 180, or initiated via a request form the user and/or application. Alternatively, in some embodiments, the vendor server 104, 180 may notify the computing device 102 of its identity based on, for example, an identifier or identification data.

In block 406, the vendor authentication module 212 determines whether the current vendor is an existing vendor (i.e., whether authentication data has been generated for the particular vendor). To do so, the vendor authentication module 212 may utilize any suitable methodology for determining whether the current vendor is an existing vendor. For example, in some embodiments, the generated authentication data is stored in the secure storage 150 in association with identification data of the corresponding vendor. In such embodiments, the vendor authentication module 212 may analyze the identification data to determine whether the current vendor is an existing vendor. Alternatively, the vendor authentication module 212 may maintain a list of existing vendors, which may be stored in the secure storage 150.

If the vendor authentication module 212 determines that the current vendor is not an existing vendor, the method 400 advances to block 408 in some embodiments. In block 408, the computing device 102 requests the user to authenticate to the computing device. That is, in some embodiments, the device authentication module 210 may require the user to authenticate to the computing device 102 for each transaction with one or more vendor servers 104, 180. Alternatively, in other embodiments, the device authentication module 210 may require the user to authenticate to the computing device only once (e.g., once per session).

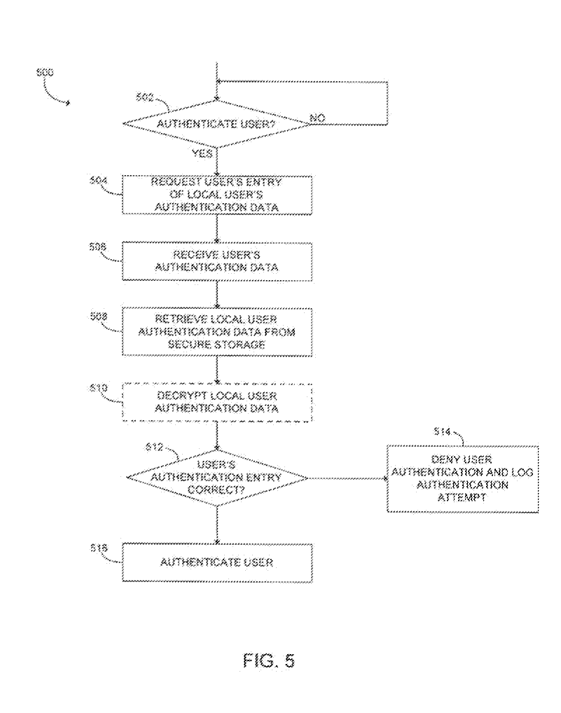

To authenticate the user to the computing device 102, the device authentication module 210 of the computing device 102 may execute a user authentication method 500 as shown in FIG. 5. The method 500 begins with block 502 in which the device authentication module 210 determines whether to authenticate the user to the computing device 102. If so, the method 500 advances to block 504 in which the device authentication module 210 requests the user to enter user authentication data. The form of such request may depend on, for example, the type of user authentication data used to authentication the user. For example, in embodiments in which the user is requested to enter a password, the device authentication module 210 may prompt the user for the password on a display screen of the computing device 102. Alternatively, in embodiments in which the user authentication data is embodied as face or voice recognition data, the device authentication module 210 may request the user to look into a camera of the computing device 102 or speak into a microphone of the computing device 102. Regardless, in block 506, the device authentication module 210 receives the user's authentication data.

In block 508, the device authentication module 210 retrieves the pre-established local user's authentication data from the secure storage 150. As discussed above, the device authentication module 210 may use the method 300 of FIG. 3 to generate the local user's authentication data for authenticating the user to the computing device 102. If the user's pre-established authentication data is stored in an encrypted state, the device authentication module 210 may decrypt the authentication data in block 510 using the cryptographic engine 156.

In block 512, the device authentication module 210 compares the retrieved, pre-established user authentication data to the user authentication data supplied to the computing device 102 in block 506. If the device authentication module 210 determines that the authentication data do not match, the method 500 advances to block 514 in which the device authentication module 210 denies the authentication of the user. In some embodiments, the event log module 216 may record the denial of authentication as a security event and/or take additional security measures as discussed above. If, however, the device authentication module 210 determines that the authentication data do match, the method 500 advances to block 516 in which the device authentication module 210 authenticates the user to the computing device 102.

Referring back to method 400 of FIG. 4, if the user is successfully authenticated to the computing device 102 in block 408, the method 400 advances to block 410 in which the vendor authentication module 212 requests a new user registration from the vendor server 104, 180. Alternatively, in some embodiments, the new user registration request may be received from the vendor server 104, 180 in block 412. Regardless, in block 414, the vendor authentication module 212 determines the authentication constraints for the vendor server 104, 180. For example, in some embodiments, the vendor authentication module 212 may request the authentication constraints directly from the vendor server 104, 180 in block 416. In response, the vendor server 104, 180 may transmit the authentication constraints to the computing device 102. For example, in some embodiments, the computing device 102 and the vendor server 104, 180 may utilizes a pre-established protocol to transfer the authentication constraints. To do so, the computing device 102 may query the vendor server 104, 180 to request the authentication constraints. The authentication constraints response may have a pre-established format (e.g., uer_id/device_id, length of password expiration of password, etc.) as part of the authentication constraints protocol or may be decided on between the computing device 102 and the vendor server 104, 180 using a suitable handshaking protocol. In response to receiving the request for authentication constraints from the computing device 102, the vendor server 104, 180 may establish a secure channel with the computing device 102 using any suitable security mechanism such as a shared secret or a Rivest-Shamir-Adleman (RSA) public key pair. The transfer of data to establish the authentication constraints, as well as the authentication constraints themselves, may be encrypted using symmetric or unsymmetric key cryptography algorithm.

Alternatively, in some embodiments, the vendor authentication module 212 may infer the authentication constraints in block 416. To do so, the vendor authentication module 212 may use any suitable methodology or algorithm, to infer the constraints on the authentication data used to authenticate the user to the vendor servers 104, 180. For example, in some embodiments, the vendor authentication module 12 may extract information from the metadata or text of a website or user screen of the vendor server 104, 180. As discussed above, the authentication constraints may be embodied as any type of data that defines or limits any quality of the authentication data used to authenticate the user to the vendor server 104, 180 as discussed above.

In some embodiments, the user of the computing device 102 may store the authentication constraints and/or user policies for generating the authentication data on a cloud or remote server. The cloud storage or backup of the authentication constraints and/or user policies allows the user to synchronize the authentication constraints, user policies, and authentication data across multiple devices.

Once the vendor authentication module 212 has determined the authentication constraints for the vendor server 104, 180, the vendor authentication module 212 may provide such authentication constraints to the authentication data generation module 214. Subsequently, in block 418, the authentication data generation module 214 generates authentication data to authenticate the user to the vendor server 104, 180 as a function of the authentication constraints. As discussed above, the authentication data generation module 214 may use any suitable methodology or algorithm to generate the authentication data. In one particular embodiment, the user authentication data is embodied as a username and associated password. In such embodiments, for example, the vendor authentication module 212 may generate each of the username and password using any suitable methodology (e.g., a randomization method) as discussed above. It should be appreciated that because the username, in addition to the password, is generated by the authentication data generation module 214, the security of the authentication data may be increased.

Additionally or alternatively, in some embodiments, the authentication data may be embodied as digital identity data that uniquely identities the computing device 102. Such digital identity data may be generated by the computing device 102 based on the root of trust of the hardware platform such as a hash of an identification number of the processor 110, a hash of a Ethernet or WiFi™ Machine Access Control (MAC) address, another hardware device identification number, or a unique random number or passkey generated by, for example, the security engine 130. It should be appreciated that use of such hardware-based digital identity data would further restrict the access to the corresponding vendor server 104, 180 to the particular platform of the computing device 102.

After the authentication data generation module 214 has generated the authentication data to authenticate the user of the computing device 102 to the respective vendor server 104, 180, the method 400 advances to block 422 in which the authentication data generation module 214 stores the newly generated authentication data in the secure storage 150. As discussed above, in some embodiments, the authentication data generation module 214 stores the generated authentication data in an encrypted state with assistance of the cryptographic engine 156. In some embodiments, the generated authentication data may be stored in association with vendor identification data to allow retrieval of the correct authentication data for each vendor server 104, 180. Additionally, in some embodiments, the authentication data is generated and stored without allowing the user of the computing device 102 to view the generated authentication data. That is, in some embodiments, the authentication data is always secured.

After the authentication data generation module 214 stores the newly generated authentication data in block 422, the computing device 102 may complete the authentication process with the new vendor in block 424. To do so, the vendor authentication module 212 may retrieve the generated authentication data from the secure storage 150 and transmit, or otherwise provide, the authentication data to the respective vendor server 104, 180. In some embodiments, the vendor server 104, 180 may occasionally request the user to update or change the authentication data (e.g., update a username or password) in block 426. If so, the method 400 loops back to block 414 in which vendor authentication module 212 determines the authentication constraints (which may have changed) for the vendor server 104, 180, and the authentication data generation module 214 generates new authentication data based on the new or previous authentication constraints in block 418. However, if no update to the authentication data is required, the method 400 advances to block 428 in which the computing device 102 completes the authentication or login process. The user may subsequently operate the computing device 102 to interact with the vendor server 104, 180 as normal.

Referring now back to block 406, if the vendor authentication module determines that the vendor is an existing vendor, the method 400 advances to block 430 in some embodiments. In block 430, the computing device 102 requests the user to authenticate to the computing device 102. As discussed above in regard to block 408, the device authentication module 210 of the computing device 102 may execute the user authentication method 500 (see FIG. 5) to authenticate the user to the computing device 102.

After the user has been successfully authenticated to the computing device 102 (or if no user authentication is required), the method 400 advances to block 432 in which the vendor authentication module 212 retrieves the previously generated authentication data corresponding to the existing vendor from the secure storage 150. As discussed above, the authentication data may be embodied as any type of data required by the vendor server 104, 180 to authenticate the user of the computing device 102. For example, in some embodiments, the authentication data is embodied as a username and associated password. In such embodiments, the vendor authentication module 212 retrieves the username and password for the existing vendor in block 434.

As discussed above, the authentication data may be stored in the secure storage 150 in an encrypted state in some embodiments. If so, the vendor authentication module 212 decrypts the authentication data in block 436 using the cryptographic engine 156. The method 400 subsequently advances to block 424 in which the vendor authentication module 212 transmits, or otherwise provides, the authentication data to the respective vendor server 104, 180. Again, in block 426, the vendor server 104, 180 may request the user to update or change the authentication data. If so, the method 400 loops back to block 414 in which vendor authentication module 212 determines the authentication constraints (which may have changed) for the vendor server 104, 180. However, if no update to the authentication data is required, the method 400 advances to block 428 in which the computing device 102 completes the authentication or login process. In this way, a user of the computing device 102 may generate and manage strong authentication data for multiple vendor servers 104, 180 with little to no interaction with the creation and/or maintenance of such authentication data.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1-68. (canceled)

69. A computing device comprising:
a vendor authentication module to receive authentication constraints from a vendor computing device to authenticate a user of the computing device to the vendor computing device; and
an authentication data generation module to generate authentication data as a function of the authentication constraints to authenticate the user to the vendor computing device,
wherein the vendor authentication module to authenticate the user to the vendor computing device by providing the generated authentication data to the vendor computing device.

70. The computing device of claim 69, wherein the authentication constraints comprise password constraints for generating a user password to authenticate the user to the vendor computing device, wherein the password constraints comprise at least one of a minimum length of characters for the password and a requirement for a non-alphabetic character.

71. The computing device of claim 69, wherein the authentication data generation module to generate a password that satisfies the authentication constraints.

72. The computing device of claim 69, further comprising a secure data storage having the authentication data stored therein, wherein the vendor authentication module is configured further to:
receive a log-on prompt from the vendor computing device;
retrieve the authentication data from the secure data storage; and
provide the authentication data to the vendor computing device to authenticate the user to the vendor computing device.

73. The computing device of claim 69, wherein the authentication data generation module further to periodically generate new authentication data as a function of the authentication constraints.

74. The computing device of claim 69, wherein authentication data generation module to generate, without input from the user, the authentication data as a function of the authentication constraints.

75. The computing device of claim 69, wherein the authentication data comprises digital identity data formed from a hardware identification number of hardware component of the computing device.

76. The computing device of claim 69, further comprising a device authentication module to authenticate the user to the computing device prior to the vendor authentication module providing the generated authentication data to the vendor computing device.

77. The computing device of claim 69, wherein:
the vendor authentication module to further receive authentication constraints from a plurality of additional vendor computing devices; and
the authentication data generation module to further generate, without input from the user, unique authentication data for each of the plurality of additional vendor computing devices as a function of the corresponding authentication constraints to authenticate the user to each of the additional vendor computing devices.

78. The computing device of claim 69, further comprising a secure storage, wherein the authentication data generation module to further store the generated authentication data in secure storage without informing the user of the identity of the authentication data.

79. One or more machine readable media comprising a plurality of instructions stored thereon that, in response to execution, causes a first computing device to:
receive authentication constraints to authenticate a user to a second computing device;
generate authentication data as a function of the authentication constraints to authenticate the user to the second computing device; and
transmit the authentication data to the second computing device to authenticate the user to the second computing device.

80. The one or more machine readable media of claim 79, wherein to receive authentication constraints comprises to receive password constraints for generating a user password to authenticate the user to the second computing device, wherein the password constraints comprises at least one of a minimum length of characters for the password and a requirement for a non-alphabetic character.

81. The one or more machine readable media of claim 79, wherein to generate authentication data comprises to generate a password that satisfies the authentication constraints.

82. The one or more machine readable media of claim 79, wherein the plurality of instructions further cause the first computing device to:
receive a log-on prompt from the second computing device;
retrieve the authentication data from a secure data storage of the first computing device; and
transmit the authentication data to the second computing device to authenticate the user to the second computing device.

83. The one or more machine readable media of claim 79, wherein the plurality of instructions further cause the first computing device to authenticate the user to the first computing device prior to the transmission of the authentication data to the second computing device.

84. The one or more machine readable media of claim 79, wherein the plurality of instructions further cause the first computing device to:
receive authentication constraints from a plurality of third computing devices;
generate, without input from the user, unique authentication data for each of the plurality of third computing devices as a function of the corresponding authentication constraints to authenticate the user to each of the third computing devices.

85. The one or more machine readable media of claim 79, wherein to transmit the authentication data to the second computing device comprises to automatically log the user into the second computing device using the authentication data without input from the user.

86. The one or more machine readable media of claim 79, wherein to receive authentication constraints comprises to receive authentication constraints in response to the user having no user account on the second computing device.

87. The one or more machine readable media of claim 79, wherein to generate authentication data comprises to generate, without input from the user, the authentication data as a function of the authentication constraints.

88. The one or more machine readable media of claim 79, to generate authentication data comprises to generate digital identity data formed from a hardware identification number of hardware component of the computing device.

89. A method comprising:
receiving, with a first computing device, authentication constraints to authenticate a user to a second computing device;
generating, on the first computing device, authentication data as a function of the authentication constraints to authenticate the user to the second computing device; and
transmitting the authentication data to the second computing device to authenticate the user to the second computing device.

90. The method of claim 89, wherein generating authentication data comprises generating a password that satisfies the authentication constraints.

91. The method of claim 89, wherein transmitting the authentication data to the second computing device comprises automatically logging the user into the second computing device using the authentication data without input from the user.

92. The method of claim 89, wherein receiving authentication constraints comprises receiving authentication constraints in response to the user having no user account on the second computing device.

93. The method of claim 89, wherein generating authentication data comprises generating, without input from the user, the authentication data as a function of the authentication constraints.
